(19) United States
(12) Patent Application Publication
(10) Pub. No.: US 2023/0273615 A1
(43) Pub. Date: Aug. 31, 2023

(54) AUTOMATED CONSTRUCTION SYSTEM AND METHOD

(71) Applicant: Ming Liao, Whittier, CA (US)

(72) Inventor: Ming Liao, Whittier, CA (US)

(73) Assignee: ECOTRON LLC, Whittier, CA (US)

(21) Appl. No.: 17/668,033

(22) Filed: Feb. 9, 2022

(51) Int. Cl. G05D 1/02; G05D 1/00; E01C 19/00; E01C 19/28

(52) U.S. Cl. CPC G05D 1/0212; G05D 1/0011; E01C 19/004; E01C 19/282; G05D 2201/0202; E01C 2301/00

(57) ABSTRACT

A system and method of organizing, managing, and controlling one or more construction vehicles (automated and/or semiautomated) to perform one or more construction tasks within a construction site is provided. The system includes a software platform programmed to control the one or more unmanned construction vehicles via a transmitter and a navigation system. The locations, routes, and general functionalities of the construction vehicles are automatically controlled.

### FIELD OF THE INVENTION

The present invention belongs to the field of construction, including systems and methods to control autonomous and/or semi-autonomous construction vehicles while performing construction tasks.

### BACKGROUND

Construction involving heavy equipment, such as road construction, is performed every day all over the world. This type of construction oftentimes includes running the heavy equipment, e.g., paver vehicles and roller vehicles, to perform repetitive tasks. For example, for road construction, a paver vehicle may lay down pavement material that roller vehicles may subsequently compact by rolling back and forth across the construction site.

However, such repetitive actions oftentimes cause operator fatigue and sometimes bodily injuries.

Accordingly, there is a need for a system to manage and control unmanned construction vehicles to perform construction work.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 shows an overview of an automated construction system in accordance with exemplary embodiments hereof;

FIG. 2 shows aspects of a software platform in accordance with exemplary embodiments hereof;

FIG. 3 shows a system workflow diagram in accordance with exemplary embodiments hereof;

FIG. 4-9 show schematics of a construction site in accordance with exemplary embodiments hereof;

FIGS. 10-13 shows rolling and seam distribution plans in accordance with exemplary embodiments hereof;

FIG. 14 shows a vibration mode strategy diagram in accordance with exemplary embodiments hereof;

FIGS. 15-18 show path strategy diagrams in accordance with exemplary embodiments hereof;

FIGS. 19A-19B show system workflow diagrams in accordance with exemplary embodiments hereof;

FIG. 20 shows a table listing of vehicle formation related parameters in accordance with exemplary embodiments hereof;

FIG. 21 shows a table listing of pavement related parameters in accordance with exemplary embodiments hereof; and

FIG. 22 depicts aspects of computing and computer devices in accordance with exemplary embodiments hereof.

### DETAILED DESCRIPTION OF EXEMPLARY EMBODIMENTS

In general, the system according to exemplary embodiments hereof provides a system and method organize, manage, and control one or more construction vehicles (automated and/or semiautomated) to perform one or more construction tasks within a construction site.

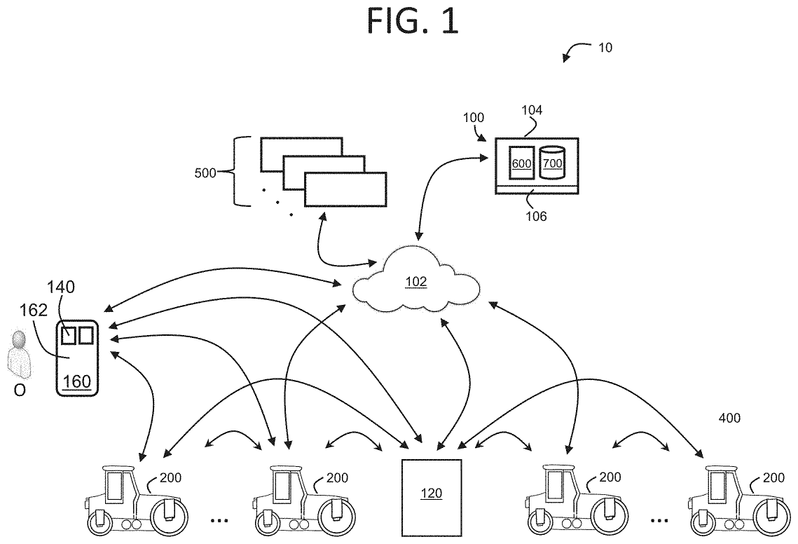

FIG. 1 shows an overview of an exemplary framework for an automated construction system 10 (also referred to herein as simply the system 10) according to exemplary embodiments hereof. As shown, the automated construction system 10 may include and/or interface with a backend controller 100, a communication system 120, and one or more construction vehicles 200. The system 10 also may interface with one or more operator(s) O of the system 10 (individually and/or collectively) via one or more application interfaces 140 (e.g., a mobile application or “app”, a browser, website or Internet interface, or other types of applications) running on one or more computing devices 160 (e.g., smart phones, tablet computers, laptops, desktop computers, mobile media players, etc.). In general, an operator O may interact with the system 10 as the system 10 controls the construction vehicles 200 to perform construction tasks within a construction site. While FIG. 1 shows one operator O and four construction vehicles 200, it is understood that the system 10 may include and/or interface with any number of operators O and/or with any number of vehicles 200 at any time. The system 10 also may include other systems, elements and components as required by the system 10 to fulfill its functionalities.

In some embodiments, the backend system 100 includes one or more servers 104 including one or more software systems 106, one or more applications 600, and one or more databases 700. The one or more software systems 106 may include operating systems, system software, web server software, social networking software, communication software, software applications, scripts, firmware, other types of software systems and any combinations thereof. The applications 600 and databases 700 will be described in other sections.

The computing devices 160 and the backend controller 100 may preferably be connected to one or more networks 102 (e.g., the Internet, LAN, WAN, wireless communication systems, cellular communication systems, telephony or other types of communication systems or protocols) and may communicate thereby. In some embodiments, the backend controller 100 may include a cloud platform (e.g., one or more backend servers), one or more local controllers, or any combination thereof. In some embodiments, the backend controller 100 includes a cloud platform that interfaces with one or more local controllers. For example, operators O of the system 10 may interface with the system 10 via a local controller in communication to a cloud platform.

In some embodiments, the mobile application 140 (“app”) provides a graphical user interface (GUI) on the display 162 of the computing device 160 that enables an operator O to interface with the application 140, the backend 100, and the overall system 10. The application 140 may generally provide an interface with which the operator O may enter information for the system 10 to utilize (e.g., upload to the backend 100), and interface controls (e.g., touchscreen buttons, etc.) for an operator O to activate while interacting with the system 10. The application 140 also may display data and other types of information that an operator O may read or otherwise consume and/or provide to other operators O. In general, and in some embodiments, the application 140 may provide a primary interface with which an operator O may interact with the system 10.

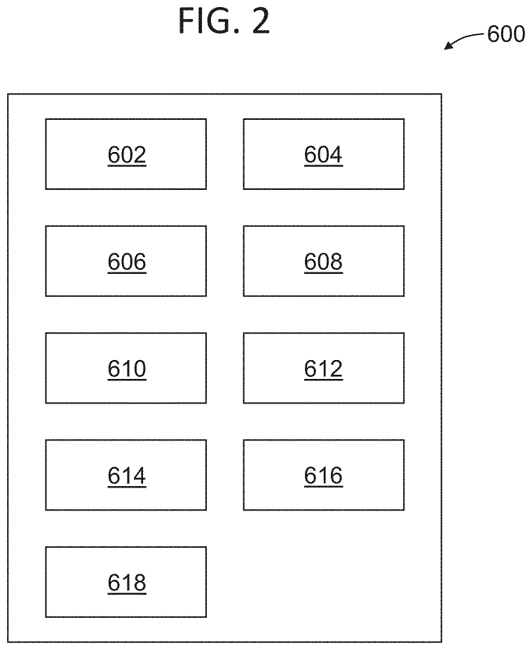

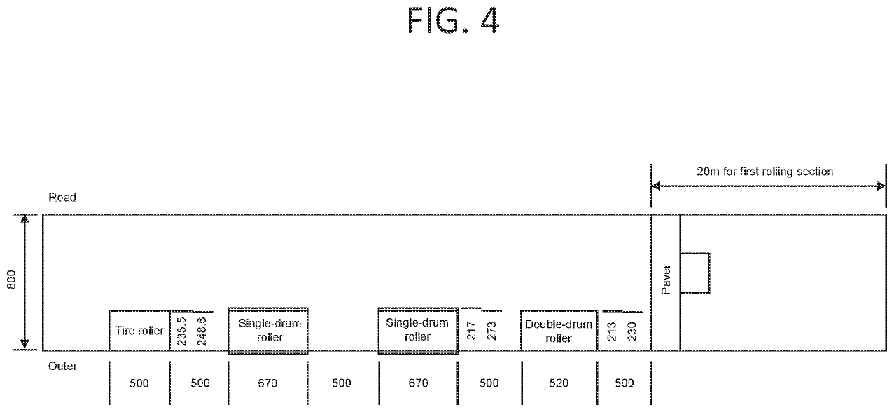

In some embodiments, as shown in FIG. 2, the system 10 comprises a software platform 600 to control the one or more unmanned vehicles 200 via the communications system 300 to perform work at a construction site 50 (see FIG. 4). In some embodiments, the software platform 600 comprising a control module 602, a vehicle management module 604, a work mode management module 606, a task management module 608, a construction work module 610, a construction management module 612, a data management module 614, a system maintenance module 616, a navigation system 618 (a GPS system), and other modules as required. The platform 600 and modules 602-618 will be described in other sections.

In some embodiments, as shown in FIG. 1, the system 10 may include, control, manage, and/or operate one or more vehicles 200 (preferably autonomous and/or semi-autonomous). In some embodiments, the vehicles 200 may include, without limitation: paver vehicle(s) 202, double-drum roller(s) 204, single-drum roller(s) 206, tire roller(s) 208, material truck(s), and/or other types of vehicles as needed (see FIG. 4)

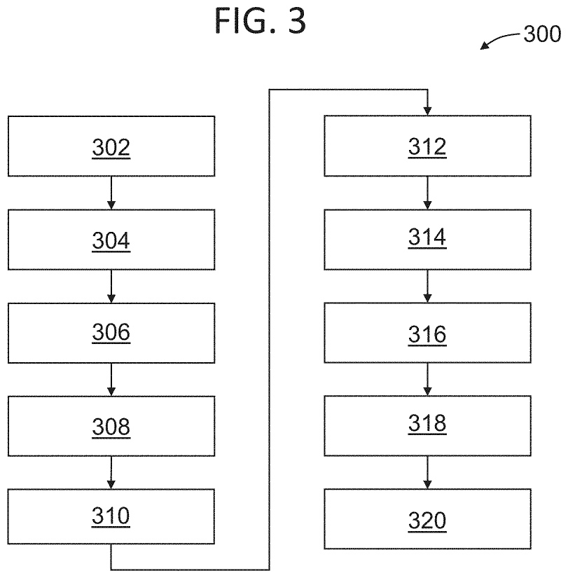

In general, and as shown in FIG. 3, the system 10 may perform the following acts 300, without limitation:

At 302, the system 10 may initialize the communication system 120. In some embodiments, the communications system 120 and associated computing devices 160 are powered on for self-inspection. In some embodiments, the communications system 120 may include one or more communications networks, e.g., 4G and/or 5G communication terminals (as a primary mode of communication) and/or local radio base stations (as a redundant backup mode of communication if the 4G and/or 5G networks are not available at the construction site 50). In some embodiments, the system 10 (e.g., the communications system 120) also includes a navigation system 618 (e.g., a GPS system including a base station) that also may be powered on for self-inspection.

At 304, the system 10 may initialize the construction vehicles 200. In some embodiments, the system 10 (with or without intervention from an operator O) may power on the vehicle(s) 200 and command the vehicle(s) 200 to each perform a self-inspection of core functionalities. The results of each self-inspection may be communicated to the system 10 (e.g., to the backend cloud platform 100) for storage and processing. If an issue is detected during the inspection(s), the system 10 may log the detected issue, inform an operator O of the issue, schedule repair and/or maintenance of the associated vehicle(s) 200, order and/or cause the replacement of any defective parts, and potentially exclude the associated vehicle(s) 200 from the construction effort.

Once the vehicles 200 are cleared for construction work, the vehicles 200 may be moved (e.g., driven, either manually and/or via remote control) to a destination within a construction site 50 (e.g., a starting or initial point 52 as shown in FIG. 4).

At 306, the system 10 may receive information representative of the physical layout of a construction site 50 (see FIG. 4). This may include site coordinates (e.g., taken by a navigation system and/or a map point collection terminal) identifying the location, boundaries, landmarks, and general shape(s) of the site 50. As described in other sections, the overall shape of the construction site 50 may be regular, irregular, and/or any combinations thereof.

At 308, the system 10 may utilize the information received in 306 to create a construction site map 30. The construction site map 30 may represent the overall shape and dimensions of the construction site 50 (as shown in FIG. 4) as well as other information (e.g., information determined and/or acquired in acts 310-312 below or otherwise). The construction site map 30 may be in digital form and/or hardcopy.

At 310, the system 10 may receive and/or determine information regarding the type(s) of construction (e.g., construction tasks) that are to be implemented within different areas of the construction site 50 (e.g., pavement related construction tasks).

Given this information, at 312, the system 10 may subdivide the construction site 50 into individual construction sections 54, with each construction section 54 including its own set of construction tasks to be implemented. In some embodiments, the system 10 may set a maximum single construction section 54 (area/size), e.g., as having a length not more than one kilometer and a width not more than 16 meters (one-way four-lane). In addition, the total construction length may be automatically allocated to multiple construction sections 54 through the system 10 (or via an operator input).

At 314, the construction sections 54 may be added to the construction site map 30 for use by the system 10 during implementation of the tasks. Each construction section 54 may be defined by its particular area, shape, and dimensions (e.g., width and length), and by the specific type(s) of construction (e.g., construction tasks) that may be performed within the section 54.

At 316, the system 10 also may select and/or determine the number and types of vehicles 200 required to perform the tasks within each construction section 54. For example, the system 10 may allocate the number and types of vehicles 200 participating in the construction process according to the construction site map 30, the identified construction tasks, the current construction site environment, available vehicles 200, and/or other construction process requirements. This may include setting the tasks for each vehicle 200, the paths of each vehicle 200, the number of passes, track overlap width, speeds of each vehicle type, requirements for sprinklers, vibration mode(s), and other parameters. In some embodiments, the path modes may include U-turns, back-and-forth rolling, diagonal translation, lane changes and other parameters.

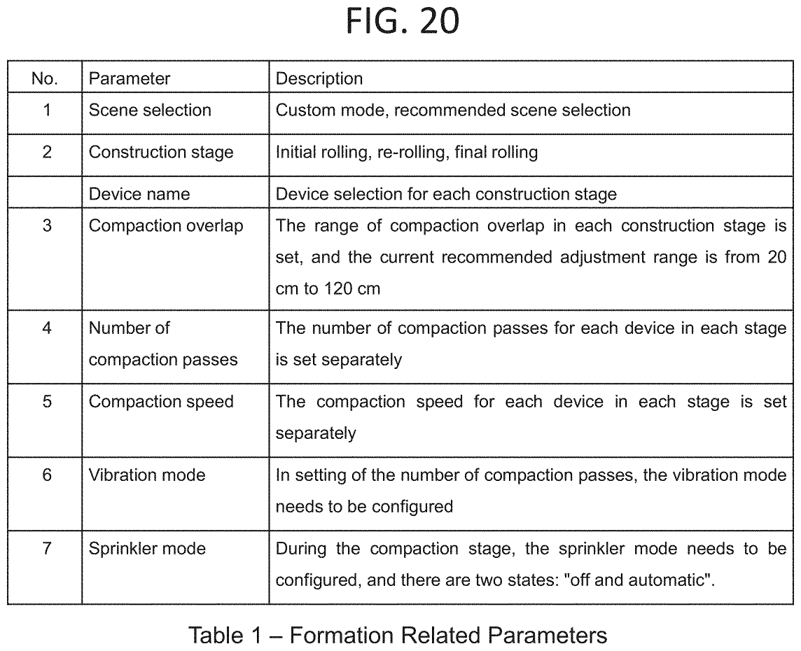

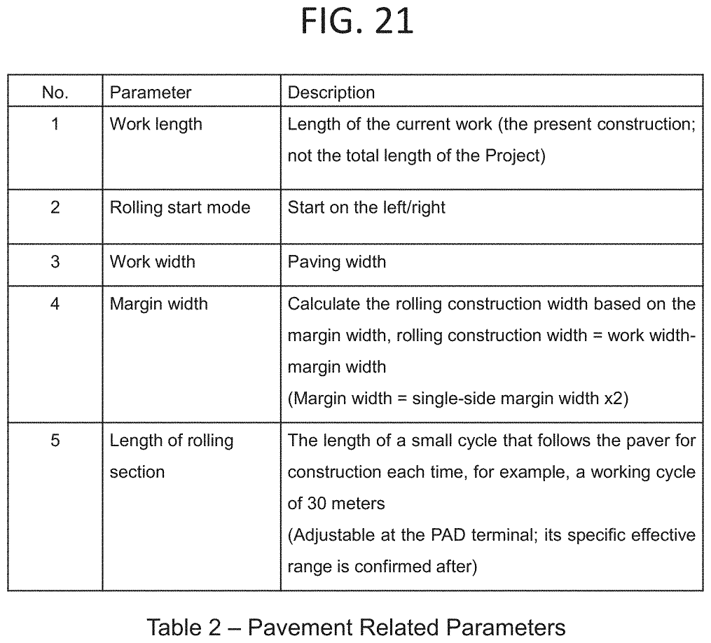

Next, at 318, the system 10 may determine and send to each vehicle 200 unique operating parameters for each vehicle 200 to utilize while performing the specified construction task(s)/type(s) within each construction section 54. The operating parameters may include control commands regarding the routes to be taken, the functions to be performed during each route, as well as other types of operating parameters. For example, the system 10 may determine and communicate to the vehicles 200 formation related parameters as shown in the Table 2 of FIG. 20 and/or pavement related parameters as shown in Table 2 of FIG. 21.

This also may include setting a vehicle formation and entry sequence of the vehicles 200. In some embodiments, the system 10 may set a minimum unit formation fleet, e.g., including one paver vehicle, two tire rollers, one single-drum roller, and one double-drum roller. In another example, the system 10 may set a no-paver vehicle mode wherein only rollers may participate in the operation. It is understood that other configurations of any types of vehicles may be implemented as required.

The system 10 also may determine and/or set a starting point of each vehicle route, a construction work length and construction subsection length, a construction work width, a margin width of a construction starting manner, a construction track overlap width, a construction stage, the number of construction compaction passes, one or more construction compaction speeds, a vibration mode of one or more construction vehicles 200, a sprinkler mode of one or more construction vehicles 200, a construction path mode(s) and/or other parameters.

In some embodiments, the vehicle formation is preferably in accordance with an initial formation, and the vehicles 200 in the formation are then driven (manually and/or automatically) to line up within a construction section 54 (e.g., behind a paver machine). It may be preferable that the vehicle formation be placed in accordance with the formation rules and the construction sequence required for the current construction. In this way, in an automatic initialization mode, when the system 10 begins the construction process, the vehicles 200 will automatically start operations and enter the construction section(s) 54 in sequence.

Then, at 320, the system 10 may oversee and generally manage the construction tasks performed by each of the vehicles 200 within each construction section 54 of the construction site 50.

In some embodiments, the system 10 may adjust the construction operation requirements in real time according to the actual construction status of the vehicle(s) 200 (e.g., according to vehicle speed, path, and the like) and the allocated construction requirements. This also may include adjusting the construction tasks depending on the status, endurance, fuel volume, fault situation, and the like of each vehicle. Accordingly, vehicles 200 with exhausted fuel or low power may be replaced and/or refueled/recharged.

Additional embodiments and details of the system 10 will be described by way of an example. The example provided below is chosen to illustrate various embodiments and implementations of the system 10, and those of ordinary skill in the art will appreciate and understand, upon reading this description, that the example is not limiting and that the system 10 may be used in different ways. It also is understood that details of different embodiments described in different examples may be combined in any way to form additional embodiments that are all within the scope of the system 10.

### Example 1

In a first example implementation of the system 10, the system 10 controls one or more unmanned vehicles 200 to pave a construction section 54 within a construction site 50. For example, the system 10 may first control a paver 202 to lay asphalt (or any other type of pavement) onto the construction section 54. Next, the system 10 may control one or more rollers 204, 206, 208 to compact (roll) the asphalt within the section 54. This may include controlling a first roller (e.g., 204) to make several passes back and forth upon the recently laid asphalt for a first compaction, followed by a second roller to make several passes back and forth upon the compacted asphalt to further compact the asphalt, followed by a third roller, and so on.

In some embodiments, as shown in FIG. 4, at the onset of the construction process, the vehicles 200 (e.g., a double-drum roller 204, a first single-drum roller 206, a second single-drum roller 206, and a tire roller 208) may be lined up in formation behind a paver machine 202 within the construction site 50 (e.g., along a graded and/or milled road). The formation may include an initial position 52 (represented by the dashed box) at which the vehicle 200 next in line to enter the construction section 54 may be placed (e.g., first in line behind the paver machine 202). The remaining vehicles 200 may then be lined up behind the first vehicle (in this case behind the double-drum roller 204) in order of expected use.

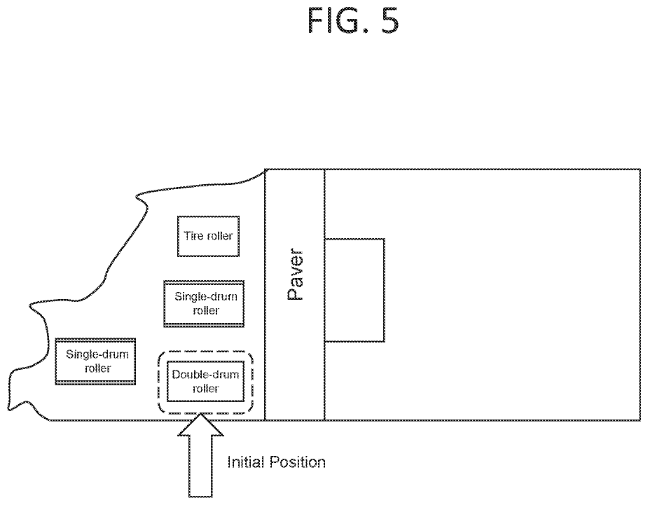

As shown in FIG. 5, if the construction site 50 does not include an area to accommodate the lined-up formation shown in FIG. 1, the first vehicle expected to enter the construction section 54 (e.g., the double-drum roller 204) may be aligned in the initial position 52 behind the paver machine 202 as shown, while the other vehicles 200 may be placed in other available locations as convenient. In this case, only the initial position 52 is restricted for use by the vehicle 200 next in line to enter the construction section 54 (in this case, the first vehicle, the double-drum roller 204). In addition, it is preferable that the other vehicles 200 are not placed in locations that may block or otherwise obstruct the first vehicle during its operation.

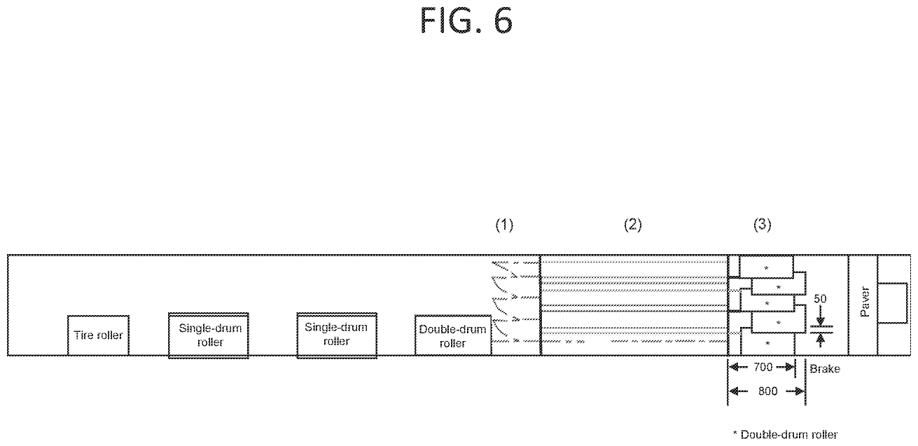

Once the vehicles 200 are arranged, the system 10 may control the paver 202 to pave a construction section 54 of the construction site 50 (e.g., the area to the right of the paver 202 as shown in FIG. 4). It is notable that in some embodiments the system 10 may not control each and every functional aspect of the paver 202, and that some of the paver's functionalities may be controlled manually by one or more operators. Once the initial laying of the asphalt is complete, the system 10 may control the first vehicle (e.g., the double-drum roller 204) to enter the paved area (the construction section 54) and perform an initial rolling route to compact the laid pavement. This may include the double-drum roller 204 making several passes down and back (left and right as shown in FIG. 6 by the arrows A within the area designated as (2)). In some embodiments, the system 10 may control the roller 204 to turn around at a particular location (e.g., at the far end in the area designated as (3) in FIG. 6) and/or to change lanes in another location (e.g., at the near end in the area designated as (1) in FIG. 6). In this way, the double-drum roller may compact the recently paved area.

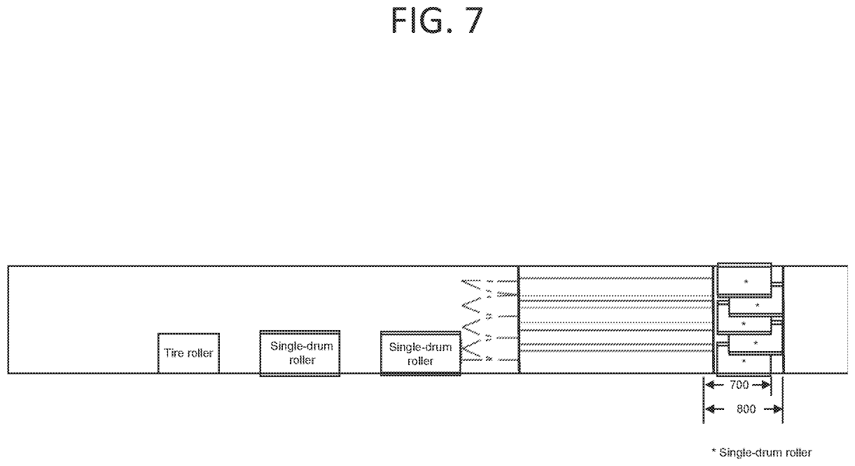

Next, as shown in FIG. 7, once the double-drum roller has completed its route, the system 10 may control the next vehicle in line (e.g., the first single-drum roller 206) to be staged at the initial location 52 for entry into the construction section 54. The system 10 may then control the first single-drum roller 206 to make several passes back and forth in the area (2) while turning around at area (3) and changing lanes as necessary at area (1). Next, the system 10 may control the second single-drum roller 206 to do the same or similar.

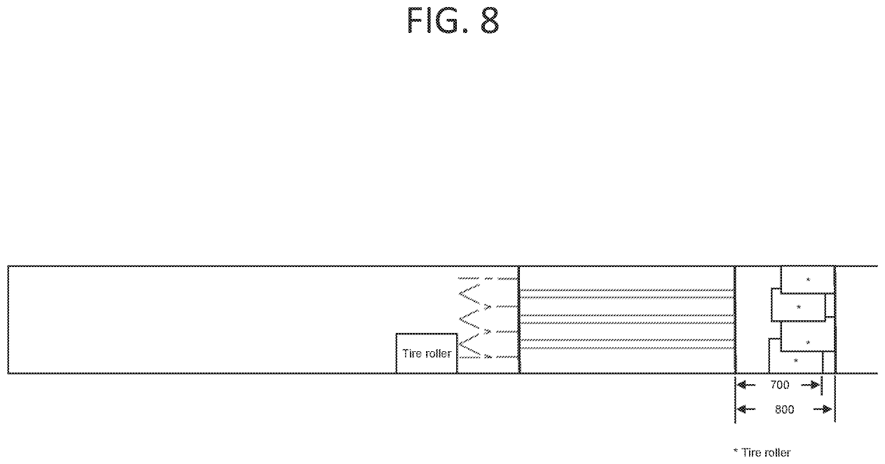

Then, as shown in FIG. 8, once the second single-drum roller 206 has completed its rolling route, the system 10 may control the next vehicle in line (e.g., the tire roller 208) to be placed at the initialization location 52 for entry into the construction section 54. The system 10 may then control the tire roller 208 to make several passes back and forth in the area (2) as shown while turning around at area (3) and changing lanes as necessary at area (1).

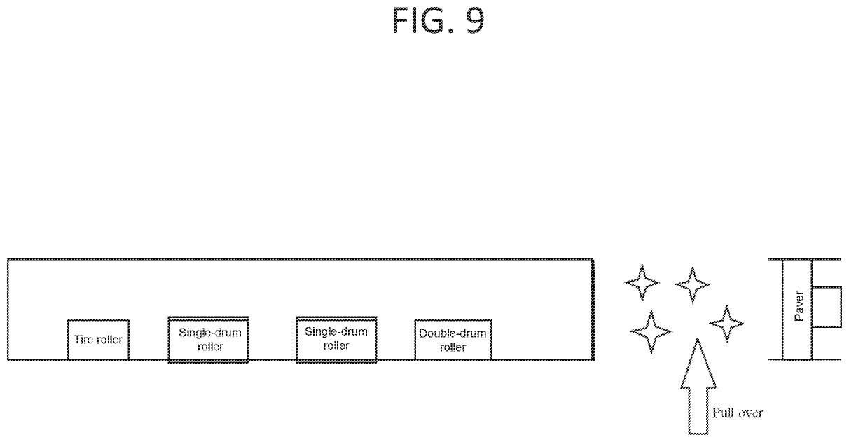

Once this process is complete as shown in FIG. 9, the vehicles 200 may be parked outside the construction section 54 and the paver 202 may be moved to a new construction section 54 of the construction site 50 to begin the process again.

In some embodiments, the system 10 controls a number of parameters during the construction process.

### Example 2

The following example complements the Example 1 above while providing additional details of the application 140 (e.g., a mobile application or “app”, a browser, website or Internet interface, or other types of applications) running on one or more computing devices 160 (tablet computer, smartphone, laptop, desktop, etc.).

First, the vehicle(s) 200 are powered on and automatically subjected to self-inspection. Then, the vehicles 200 are driven to a destination by drivers or under remote control by the system 10. During these operations, the application 140 may display a dialogue window to prompt the operator O during the process, such as “initialization failed”, “location violation, unable to initialize”, “please confirm that Vehicle XXX has been placed in the initialization position”, etc. The application 140 may display a “Paver Starts Working” button on a device 160 to notify the navigation system 618 that it can start recording GPS positioning points and generating vehicle routes. Alternatively, the application 140 may display a “Construction Start” button to commence the construction.

Next, the user may use the device 160 to create the construction task information, e.g., task name, operator, weather conditions, etc. These tasks may then be saved and/or uploaded to the backend 100.

Next, construction tasks may be configured using the device 160, then saved and uploaded to the backend 100. In addition, a scene selection may be recommended. At least some of these construction tasks are shown in Table 1 of FIG. 20 (formation related parameters), and/or in Table 2 of FIG. 21 (pavement related parameters).

Next, after the configuration is complete, the operator O may click “Submit” to enter the next operation page “Construction Information and Control”

This may bring the operator O to an unmanned operation control and status page where construction start, pause, and cancel commands may be implemented. For example, a start command may start construction with one or more vehicles 200, a pause commence may stop one or more vehicles 200 from performing construction tasks, and a cancel command may cancel all tasks.

Next, vehicles 200 finishing the last stage of construction may be controlled to wait at the starting point 52 of the next stage (e.g., the next construction section 54). During the waiting process, it may be preferable that the vehicles 200 not stop, and instead, continue to run in reciprocating pattern(s) until the construction is continued at the next section 54. For example, the reciprocating pattern may be within the compaction range of the first straight line before the starting point of the next construction section 54.

Next, the system 10 (via the application 140) may implement a finishing mode to the last section 54 of construction. If the construction of the second-to-last section 54 has not started, it may be merged with the last remaining section 54 for construction, and the application 140 may prompt the operator with a message “Remaining section merging construction”. If the construction of the second-to-last section 54 has started, the last remaining section 54 may be constructed independently, and the application 140 may prompt the operator O with “Remaining section independent construction”. Then, if the construction length of the last independent section 54 is less than 3 meters (or another suitable threshold), the application 140 may prompt the operator O with “Unmanned construction is not possible, please intervene manually”.

In some embodiments, the application 140 may provide a progress preview that may preview the total progress (e.g., progress of a complete project), progress of current task (progress of the day, finalized routine/current total mileage), etc.

In some embodiments, the application 140 may provide real-time compaction values, that is, digital display(s) of compactness sensor data received from each vehicle 200.

In addition, the application 140 may enable the operator O to control the vibration and/or sprinkling functionalities of each vehicle 200 in real time as required.

As shown in FIG. 6 (e.g., during the initial rolling stage of the first vehicle 204), the vehicle 204 conducts automated construction according to the construction task(s) chosen by the operator O via the application 140 in addition to construction information determined by the system 10. After the initialization of the vehicles 200 and the start of construction, each vehicle 200 may (sequentially) enter the construction section 54 in turn and complete the construction of the stage.

As shown in FIG. 7, in the re-rolling stage, after the initial rolling stage has been completed by the first vehicle 204, the vehicles 206, 208 in the re-rolling stage may enter the field to complete the construction of this stage in turn.

As shown in FIG. 8, after the re-rolling stage(s) have been completed, the vehicles 200 may proceed to a new construction section 54 in sequence. According to the strategy of the dispatching system 10, it is ensured that no conflict or collision occurs in the cross-regional construction of the two stages.

As shown in FIG. 9, when the construction is completed and/or the operator O has implemented an end operation via the application 140, the construction of the section 54 may end. The paver 202 may then move to a new construction section 54, and the vehicles 200 may be parked in waiting and/or realigned behind the paver 202.

### Example 3

The following example complements Examples 1 and 2 above while providing additional details of the software platform 600. As described in other sections, the system's software platform 600 may comprise a control module 602, a vehicle management module 604, a work mode management module 606, a task management module 608, a construction work module 610, a construction management module 612, a data management module 614, a system maintenance module 616, and other modules as required.

In some embodiments, the system 10 (e.g., the vehicle management module 604) manages information pertaining to the vehicles 200. For example, the vehicle management module 604 may store and process information pertaining to the identification of the vehicles 200. This may include the vehicle type, vehicle ID code, vehicle size, weight, speed capability, fuel volume, battery level (e.g., if the vehicle 200 is electric), roller size, vibration mode, other types of identifiers and any combination thereof. This also may include the vehicle location, vehicle status (On/Off status, engine speed, vehicle speed, roller speed, vibrating or not in rolling, tire pressure, engine oil temperature, coolant temperature, current mode, etc.), and start and stop control.

In general, the construction management module 612 is configured to manage the construction work module 610, the data management module 614 is configured to perform data statistics on the task management module 608, the system maintenance module 616 is configured to maintain operational safety of each module, and the vehicle management module 604 is configured for vehicle 200 type management, vehicle 200 parameter management, vehicle 200 code management, fault diagnosis and vehicle 200 maintenance.

The vehicle type management includes pavers 202, double-drum rollers 204, single-drum rollers 206, tire rollers 208, material trucks, and/or other types of vehicles.

The work mode management module 606 includes a debugging mode, and the debugging mode includes an unmanned operation mode, a no-paver mode, a long-range control mode, and a remote control mode.

The task management module 608 is configured to manage input of operation task data, construction site environment, operator number input, corresponding constructor number, and weather status records on the day of construction. The operation task data includes name, location, mileage, length, width, total number of available vehicles 200, pavement requirement(s), and construction period. The construction site environment includes soil quality, hardness of ground surface, and humidity.

The construction work module 610 may include a construction preparation module and a construction process model module.

In some embodiments, an operator O may use an operating platform to adjust the vehicle mode to a remote control mode or to a long-range control mode as required. The operator O may use the operating platform to adjust the vehicle mode at any time to the remote control mode or long-range control mode, and the operator O may control the vehicle 200 remotely and/or from a long range to reach a starting point 52 of a construction section 54.

The construction management module 612 is configured for construction control and flow management, and execution of the arranged construction flow and process, the data management module 614 is configured to process statistics regarding the completion of current tasks, statistics on construction efficiency and raw material consumption, and may provide suggestions for construction optimization. The system maintenance module 616 is configured to maintain the safety of the system 10.

### Example 4

Example 4 generally pertains to a pavement and roller construction process.

In some embodiments, the following parameters may be defined, implemented, controlled, and maintained by the system 10.

Overlap of construction paths: The system 10 controls the vehicles 200 and the vehicle path(s) such that the paths of the rollers 204-208 overlap each time.

Number of rolling passes: One rolling time (or one rolling trip) is generally defined as a roller 204-208 rolling back and forth along the same or similar wheel tracks once. One pass is generally defined as all rolling times (or trips) being completed. The number of rolling trips refers to the number of round-trips for compaction by the roller 204-208 to complete the rolling work of all the road surfaces in the construction section 54. This also can be calculated by dividing the width of the construction section 54 by the roller width-overlap area, and then rounding up.

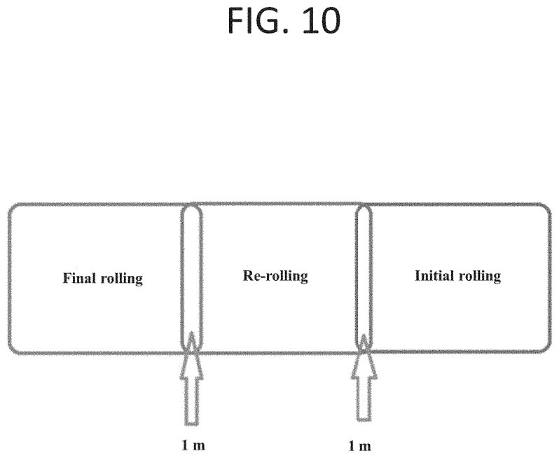

Seam treatment: Intersections between different construction sections 54 preferably include seams that may be treated to connect the construction sections 54 together. If there are more than two vehicles 200 for construction, seams also need to be treated for connection. For example, for an 8 m wide road, two vehicles 200 each roll 4.5 m. The distribution plan for this is shown in FIG. 10, showing an initial rolling portion, a re-rolling portion, a final rolling portion, and the seams between the portions. The widths of the above two seams can be configured through the system 10 (e.g., this type of configuration may be hidden in the “advanced mode” or “debugging mode” of the application 140).

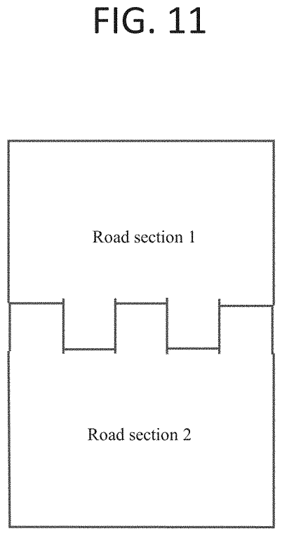

For seam treatment, it is preferable that intersections between different construction sections 54 (e.g., road sections) include seams that are connected. The distribution plan is shown in FIG. 10 and FIG. 11 showing a first road section and a second road section and the seam(s) in between.

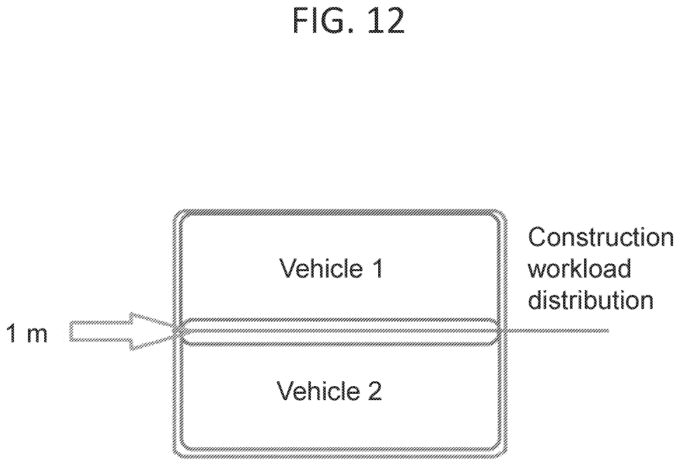

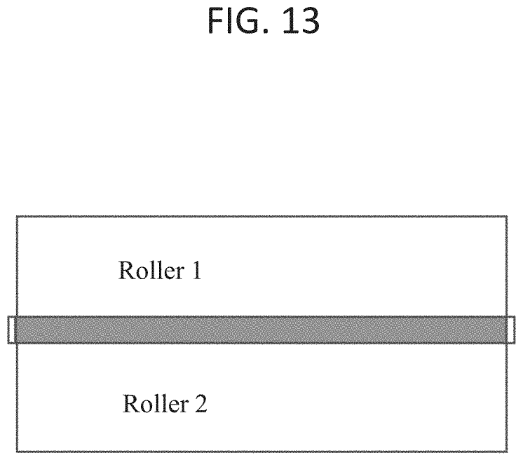

If there are more than two vehicles 200 in the construction section 54, seam connection is also required at the intersection. For example, for an 8 m wide road, two vehicles 200 each roll 4.5 m, at the intersection of the seams, and the two vehicles 200 run for rolling repeatedly. The distribution plan for this is shown in FIG. 12 and FIG. 13. For the widths of the above two seams, seam treatment methods can be configured through the software platform 600, including seam width, length, zigzag crossing, smooth crossing, and the like.

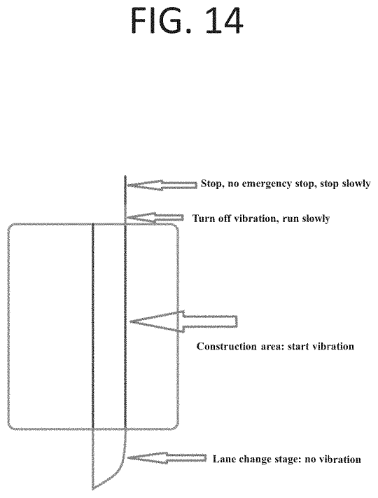

Vibration strategy: Current start conditions may include vehicle speeds ≥0.5 km/h in response to the vibration start command. This is shown in FIG. 14 showing where a vibration mode should be turned on within the construction area and off outside the construction area (e.g., during a lane change).

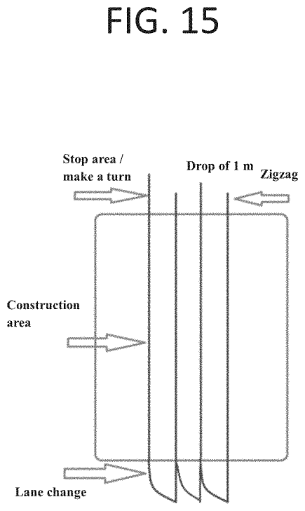

Path strategy: The path may be in a stop area, with a zigzag drop, e.g., of 1 meter. The drop may be adjustable with a range of 0 to 3 meters and can be configured through the system 10. This type of configuration may be hidden to “advanced mode” or “debug mode” of the application 140. This is shown in FIG. 15. The path drop during construction can be used to place road faults, that is, the previous construction road and the current construction road may be connected in a zigzag pattern. This may effectively prevent the resulting road from cracking or faulting at the construction junction(s), and it is convenient for the scheduling system to identify and calculate the construction path.

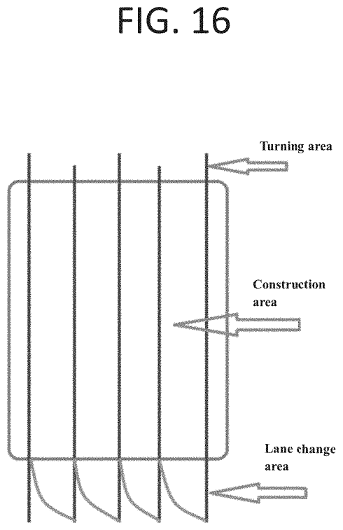

FIG. 16 shows one round of a construction path, that is, one complete round of construction process. In the figure, the construction is conducted from the right to the left. In actual situations, the construction also may be conducted from the left to the right.

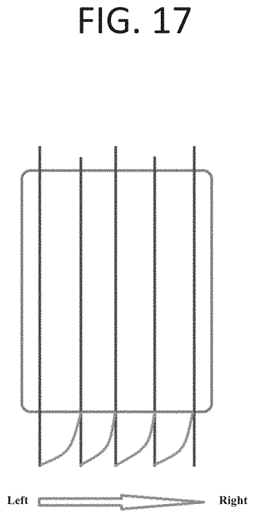

As shown in FIG. 17, the second round of construction may require a vehicle 200 to drive to the starting point 52 and repeat the first round of construction.

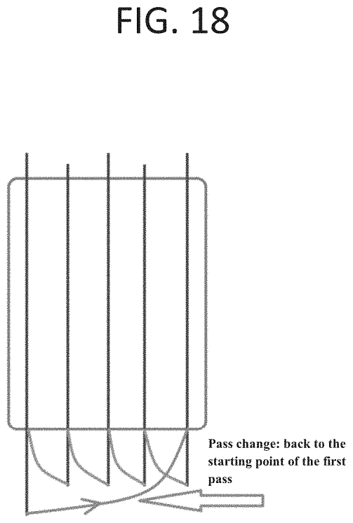

As shown in FIG. 18, for lane change(s), a vehicle 200 may move straight back and then move forward to change another lane. The lane change distance may be confirmed by the optimal control through experiments to determine the minimum lane change distance. A temporary lane change distance may be 10 m, which is preferably greater than the minimum turning radius. During pass change, after the last trip of compaction is completed, a vehicle 200 may continue to move back a certain distance in a straight line, and then change the lane forward to the start position 52. The temporary pass change distance may be about 15 m, which is greater than 1.5 times of the vehicle's turning radius.

Construction area (i.e., the determination of the construction site 50 boundary): The construction site 50 (e.g., road under construction) may generally be straight, diagonal, C-shaped or S-shaped.

Regular shape (e.g., a straight line and/or an oblique line): The corner coordinate points of the construction site 50 may be collected by a drawing device and used to determine the closed area. The system 10 then uses this information to determine the construction site boundary.

Irregular shape (C-shaped and S-shaped curves). The drawing device collects the corner points of the construction site 50 boundary, and if a curve is detected, the two ends and middle points of the curve are collected. In this way, the system 10 may calculate the curve trend using the two ends and middle points of the curve to form an enclosed area (the construction site 50 boundary). Alternatively, a straight line fit using the corner points may be used.

Construction path: The system 10 may first determine the starting point and start method of construction, e.g., the starting point and the direction that the construction may proceed (e.g., left-to-right and/or right-to-left). Taking the case where the construction starts from the right side as an example, when the enclosed boundary of the construction site 50 is established, the system 10 may calculate the number of allowable horizontal construction paths in the construction site 50 (and/or construction section 54) according to the width of the construction section 54, the width of the roller 204-208, the width of the margin, and the overlap width. Partial overlap on the last and penultimate paths also may be allowed.

Formation construction path method: In some embodiments (e.g., for drop construction), the system 10 may define the construction paths as 1, 2, 3 . . . N. The first roller 204 may first conduct a compacting operations along path 1, then move to path 3 after completing one pass of rolling, and then move to path 5 after completing another one pass of rolling. Meanwhile, a second roller 206 may conduct compacting operations along path 2. Accordingly, the paths of the first roller 204 may include path 1, path 3, path 5 . . . path N, and the paths of the second roller 206 may include path 2, path 4, path 6 . . . path N+1. The system 10 controls the paths, parking and waiting of the rollers 204-208 in real time according to the operation progress of the rollers 204-208, so as to avoid collisions and improve the efficiency of the operation. The rollers 204-208 may work until all the compaction passes and the compactness requirements are met. In some instances, this method may be appropriate when the width of the construction section 54 exceeds the width of the roller 204-208 by more than 3 times during initial rolling.

Traverse the construction: The system 10 may define the construction paths as 1, 2, 3 . . . N. The first roller 204 may first conduct compacting operation along path 1, then move to path 2 after completing the first one pass of rolling, and then move to path 3 after completing another one pass of rolling, thereby traversing all the paths until all the compaction passes and compactness requirements are met. Because the construction process may involve cross operation of tire rollers 208, single-drum rollers 206, and double-drum rollers 204, this method is often used in the construction process when the construction area is not overly too wide.

Lane change: After a roller 204-208 completes one pass of compaction and returns to the starting point 52, the system 10 plans the starting point of the next path according to the determined construction path mode. The system 10 then plans a best moving path from the current starting point 52 to the next starting point and sends the best moving path to the roller 204-208. The roller 204-208 automatically moves to the next starting point according to the path and starts the operation along the new path. When planning the next starting point, the system 10 may calculate the starting point position of the next path in combination with the path mode and the drop requirements.

After completing all compaction passes, the system 10 may cause the roller 204-208 to return to the starting point of the last path. The system 10 then may plan a path from the current starting point to the stop point and send the path to the roller 204-208. The roller 204-208 may then automatically run to the stop point along the path and stop.

Pass change: After a roller 204-208 completes the compaction passes of the current operation stage and achieves the compactness target, the system 10 may arrange the rollers 204-208 required for the work to enter the construction section 54 according to the requirements of the next stage of construction tasks for that section 54. If the re-rolling is started after the initial rolling is completed, the system 10 may recalculate a compaction path and a path mode according to the process requirements, i.e., the number of compaction passes, compaction requirements, working model, working width, margin width, repetition width and other parameter requirements in the re-rolling stage.

Recommended Parameters

Track overlap: A range of 20 cm to 120 cm (adjustable using the application 140) may be temporarily provided

Vehicle 200 recommended speed ranges:

Tire roller 208 SRT30H: 0-13 km/h

Single-drum roller 206 SR26: 0-10 km/h, SR36: 0-9 km/h

Double-drum roller 204 SRD14: 0-12 km/h, SRD13: 0-11 km/h

Table 3 below shows recommended asphalt compaction speeds:

TABLE 3
Rolling speed of roller (km/h)

| | Initial rolling | | Re-rolling | | Final rolling | |
|---|---|---|---|---|---|---|
| Roller | | Maxi- | | Maxi- | | Maxi- |
| type | Proper | mum | Proper | mum | Proper | mum |
| Steel- | 2-3 | 4 | 3-5 | 6 | 3-6 | 6 |
| drum | | | | | | |
| roller | | | | | | |
| Tire | 2-3 | 4 | 3-5 | 6 | 4-6 | 8 |
| roller | | | | | | |
| Vibrating | 2-3 (static | 3 (static | 3-4.5 | 5 | 3-6 (static | 6 |
| roller | pressure | pressure | (vibration) | (vibration) | pressure) | (static |
| | or | or | | | | pressure) |
| | vibration) | vibration) | | | | |

Table 4 below shows recommended compactness of cement stabilized base:

TABLE 4
Compactness of cement stabilized base

| | Initial rolling | | Re-rolling | | Final rolling | |
|---|---|---|---|---|---|---|
| Roller | | Maxi- | | Maxi- | | Maxi- |
| type | Proper | mum | Proper | mum | Proper | mum |
| Single- | 15-2.0 | 3 (static | 20-2.5 | 4 | 2.0-2.5 | 4 |
| drum | (static | pressure) | (vibra- | (vibra- | | |
| roller | pressure) | | tion) | tion) | | |
| Double- | 15-2.0 | 3 (static | — | — | 2.0-2.5 | 4 |
| drum | (static | pressure) | | | | |
| roller | pressure) | | | | | |
| Tire | 1.5-2.0 | 3 | 2.0-2.5 | 4 | 2.0-2.5 | 4 |
| roller | | | | | | |

Note:
Speed unit is km/h.

Table 5 below shows recommended construction models:

TABLE 5
Construction models

| Wheel track | 1 m | | Paving | 8 m | |
|---|---|---|---|---|---|
| pitch | | | width | | |
| Length of | 40 m | | Margin | Steel-containing | |
| work section | | | distance | membrane support is | |
| Construction | Cement stabilized | | | tested and determined | |
| scene | base paving | | | | |
| | | | Number | Track | |
| | Device | Speed | of passes | overlap: | Vibration |
| Initial rolling | SR26-C5U | 2 km/h | 4 | 20 cm- | 1 Static |
| | | | | 120 cm | |
| | SR26-C5U | 2 km/h | | 20 cm- | 2 small |
| | | | | 120 cm | 3/4 large |
| Re-rolling | SRT30-C5U | 2 km/h | 2 | 80 cm- | Static |
| | | | | 120 cm | |
| Final rolling | SRD14-C5U | 2 km/h | 2 | 20 cm- | Static |
| | | | | 120 cm | |

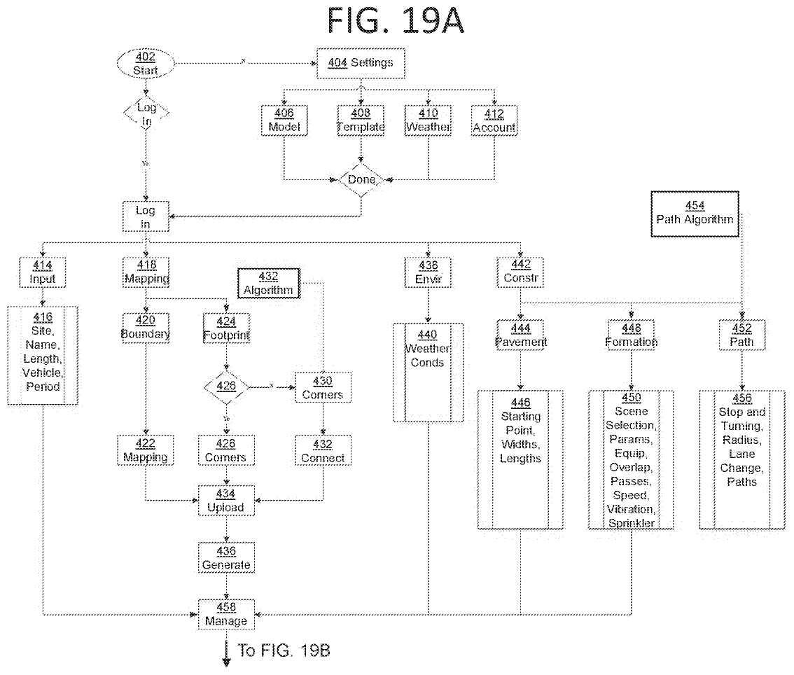

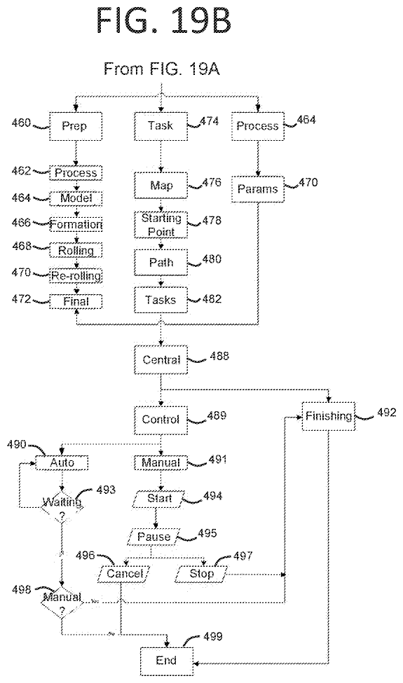

FIGS. 19A-19B show a workflow 400 of the system 10 according to some embodiments. At 402 a user may log into the system 10. The user may choose to set the basic function settings at 404, including model parameter input at 406, construction process template settings at 408, weather environment template settings at 410, and system account settings at 412.

At 414, the user may perform construction task input including, at 416, construction site, task name, construction length, construction vehicle(s), construction period requirements, and engineering section(s).

At 418, the user may perform mapping functionalities, including boundary mapping at 420 (which may include driving around the border of the site with a map collecting device to form a closed area at 422). This also may include footprint mapping at 424. If the boundary is deemed as a regular shaped boundary at 426, the user, at 428, may collect the corner points around the construction area and connect them to form the boundary. If the boundary is deemed as irregularly shaped at 426, the user, at 430, may collect the corner points of the boundary of the construction site and the two ends and the middle points of the curve to determine the boundary. This also may utilize an algorithm for defining the boundary of an irregular shaped construction area at 432. At 432, the irregular intervals may be connected to form a closed area. The boundary information collected above then may be uploaded to the system 10 at 434 at which time the system 10 may generate the construction map at 436.

At 438, the user may collect construction environment parameters including at 440, weather conditions, air humidity, roadbed material, and roadbed humidity.

At 442, the user may collect construction process information including pavement process parameters at 444 including, at 446, starting point position, single-work length, work width, margin width, length of rolling section, etc., formation process at 448 including, at 450, scene selection, initial rolling parameters, re-rolling parameters, final rolling parameters, construction equipment, compaction overlap, number of compaction passes, compaction speed, vibration strategy, sprinkler mode, etc., and formation path strategy at 452, including using a path strategy algorithm a 454 and, at 456, stop and turning area parameters, lane change radius, lane change mode, drop construction path, traverse the construction paths, etc.

At 458, the information collected above may be provided to the construction management module 612.

Continuing to FIG. 19B, the user may perform construction preparation at 460 including process confirmation at 462, model confirmation at 464, formation model check at 466, initial rolling stage at 468, re-rolling stage at 470 and final rolling stage at 472.

Task creation may be performed at 474 including map download at 476, starting point confirmation at 478, path strategy confirmation at 480, and section tasks at 482.

Process monitoring may be performed including monitoring parameter configuration(s) on actions 460-472 at 484 at 486.

The information garnered above may be provided to the construction control module (e.g., the construction work module 610 and/or the construction management module 612) at 488. A control mode may be determined at 489 including automatic control at 490, manual control at 491, either of which also may include a finishing mode at 492. The process may enter a waiting mode at 493, a start at 494, a pause at 495, a cancel the task at 496, a stop at 497, and a decision to finish manually or not at 498. The process may stop at 499.

It is understood that the actions described in example above are meant for demonstration and that other actions also may be taken. It also is understood that not all of the actions must be taken, and that the actions may be taken in different orders.

It also is understood that any aspect or element of any embodiment of the system 10 as described herein or otherwise can be combined with any other embodiment of the system 10 to form additional embodiments of the system 10, all of which are in the scope of the system 10.

Computing

The services, mechanisms, operations and acts shown and described above are implemented, at least in part, by software running on one or more computers or computer systems or devices. It should be appreciated that each user device is, or comprises, a computer system.

Programs that implement such methods (as well as other types of data) may be stored and transmitted using a variety of media (e.g., computer readable media) in a number of manners. Hard-wired circuitry or custom hardware may be used in place of, or in combination with, some or all of the software instructions that can implement the processes of various embodiments. Thus, various combinations of hardware and software may be used instead of software only.

One of ordinary skill in the art will readily appreciate and understand, upon reading this description, that the various processes described herein may be implemented by, e.g., appropriately programmed general purpose computers, special purpose computers and computing devices. One or more such computers or computing devices may be referred to as a computer system.

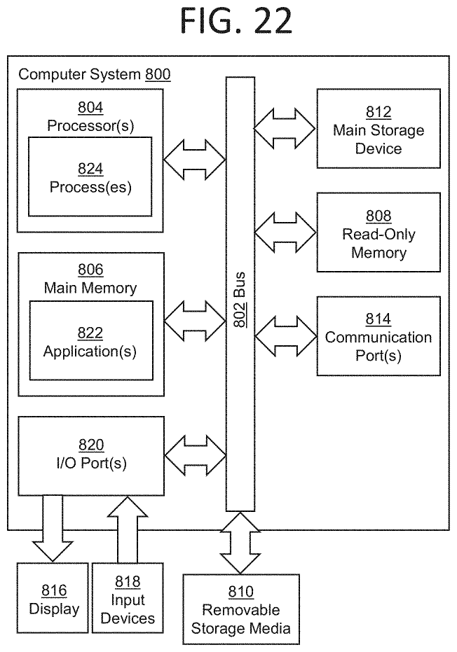

FIG. 22 is a schematic diagram of a computer system 800 upon which embodiments of the present disclosure may be implemented and carried out.

According to the present example, the computer system 800 includes a bus 802 (i.e., interconnect), one or more processors 804, one or more communications ports 814, a main memory 810, removable storage media 810, read-only memory 808, and a mass storage 812. Communication port(s) 814 may be connected to one or more networks by way of which the computer system 800 may receive and/or transmit data.

As used herein, a “processor” means one or more microprocessors, central processing units (CPUs), computing devices, microcontrollers, digital signal processors, or like devices or any combination thereof, regardless of their architecture. An apparatus that performs a process can include, e.g., a processor and those devices such as input devices and output devices that are appropriate to perform the process.

Processor(s) 804 can be (or include) any known processor, such as, but not limited to, an Intel® Itanium® or Itanium 2® processor(s), AMD® Opteron® or Athlon MP® processor(s), or Motorola® lines of processors, and the like. Communications port(s) 814 can be any of an RS-232 port for use with a modem-based dial-up connection, a 10/100 Ethernet port, a Gigabit port using copper or fiber, or a USB port, and the like. Communications port(s) 814 may be chosen depending on a network such as a Local Area Network (LAN), a Wide Area Network (WAN), a CDN, or any network to which the computer system 800 connects. The computer system 800 may be in communication with peripheral devices (e.g., display screen 810, input device(s) 818) via Input/Output (I/O) port 820. Some or all of the peripheral devices may be integrated into the computer system 800, and the input device(s) 818 may be integrated into the display screen 810 (e.g., in the case of a touch screen).

Main memory 810 can be Random Access Memory (RAM), or any other dynamic storage device(s) commonly known in the art. Read-only memory 1608 can be any static storage device(s) such as Programmable Read-Only Memory (PROM) chips for storing static information such as instructions for processor(s) 804. Mass storage 812 can be used to store information and instructions. For example, hard disks such as the Adaptec® family of Small Computer Serial Interface (SCSI) drives, an optical disc, an array of disks such as Redundant Array of Independent Disks (RAID), such as the Adaptec® family of RAID drives, or any other mass storage devices may be used.

Bus 802 communicatively couples processor(s) 804 with the other memory, storage and communications blocks. Bus 802 can be a PCI/PCI-X, SCSI, a Universal Serial Bus (USB) based system bus (or other) depending on the storage devices used, and the like. Removable storage media 810 can be any kind of external hard-drives, floppy drives, IOMEGA® Zip Drives, Compact Disc-Read Only Memory (CD-ROM), Compact Disc-Re-Writable (CD-RW), Digital Versatile Disk-Read Only Memory (DVD-ROM), etc.

Embodiments herein may be provided as one or more computer program products, which may include a machine-readable medium having stored thereon instructions, which may be used to program a computer (or other electronic devices) to perform a process. As used herein, the term “machine-readable medium” refers to any medium, a plurality of the same, or a combination of different media, which participate in providing data (e.g., instructions, data structures) which may be read by a computer, a processor, or a like device. Such a medium may take many forms, including but not limited to, non-volatile media, volatile media, and transmission media. Non-volatile media include, for example, optical or magnetic disks and other persistent memory. Volatile media include dynamic random access memory, which typically constitutes the main memory of the computer. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications.

The machine-readable medium may include, but is not limited to, floppy diskettes, optical discs, CD-ROMs, magneto-optical disks, ROMs, RAMs, erasable programmable read-only memories (EPROMs), electrically erasable programmable read-only memories (EEPROMs), magnetic or optical cards, flash memory, or other type of media/machine-readable medium suitable for storing electronic instructions. Moreover, embodiments herein may also be downloaded as a computer program product, wherein the program may be transferred from a remote computer to a requesting computer by way of data signals embodied in a carrier wave or other propagation medium via a communication link (e.g., modem or network connection).

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols; and/or (iv) encrypted in any of a variety of ways well known in the art.

A computer-readable medium can store (in any appropriate format) those program elements that are appropriate to perform the methods.

As shown, main memory 810 is encoded with application(s) 822 that support(s) the functionality as discussed herein (an application 822 may be an application that provides some or all of the functionality of one or more of the mechanisms described herein). Application(s) 822 (and/or other resources as described herein) can be embodied as software code such as data and/or logic instructions (e.g., code stored in the memory or on another computer readable medium such as a disk) that supports processing functionality according to different embodiments described herein.

During operation of one embodiment, processor(s) 804 accesses main memory 810 via the use of bus 802 in order to launch, run, execute, interpret or otherwise perform the logic instructions of the application(s) 822. Execution of application(s) 822 produces processing functionality of the service(s) or mechanism(s) related to the application(s). In other words, the process(es) 824 represents one or more portions of the application(s) 822 performing within or upon the processor(s) 804 in the computer system 800.

It should be noted that, in addition to the process(es) 824 that carries (carry) out operations as discussed herein, other embodiments herein include the application 822 itself (i.e., the un-executed or non-performing logic instructions and/or data). The application 822 may be stored on a computer readable medium (e.g., a repository) such as a disk or in an optical medium. According to other embodiments, the application 822 can also be stored in a memory type system such as in firmware, read only memory (ROM), or, as in this example, as executable code within the main memory 810 (e.g., within Random Access Memory or RAM). For example, application 822 may also be stored in removable storage media 810, read-only memory 808, and/or mass storage device 812.

Those skilled in the art will understand that the computer system 800 can include other processes and/or software and hardware components, such as an operating system that controls allocation and use of hardware resources.

As discussed herein, embodiments of the present invention include various steps or operations. A variety of these steps may be performed by hardware components or may be embodied in machine-executable instructions, which may be used to cause a general-purpose or special-purpose processor programmed with the instructions to perform the operations. Alternatively, the steps may be performed by a combination of hardware, software, and/or firmware. The term “module” refers to a self-contained functional component, which can include hardware, software, firmware or any combination thereof.

One of ordinary skill in the art will readily appreciate and understand, upon reading this description, that embodiments of an apparatus may include a computer/computing device operable to perform some (but not necessarily all) of the described process.

Embodiments of a computer-readable medium storing a program or data structure include a computer-readable medium storing a program that, when executed, can cause a processor to perform some (but not necessarily all) of the described process.

Where a process is described herein, those of ordinary skill in the art will appreciate that the process may operate without any user intervention. In another embodiment, the process includes some human intervention (e.g., a step is performed by or with the assistance of a human).

As used in this description, the term “portion” means some or all. So, for example, “A portion of X” may include some of “X” or all of “X”. In the context of a conversation, the term “portion” means some or all of the conversation.

As used herein, including in the claims, the phrase “at least some” means “one or more,” and includes the case of only one. Thus, e.g., the phrase “at least some ABCs” means “one or more ABCs”, and includes the case of only one ABC.

As used herein, including in the claims, the phrase “based on” means “based in part on” or “based, at least in part, on,” and is not exclusive. Thus, e.g., the phrase “based on factor X” means “based in part on factor X” or “based, at least in part, on factor X.” Unless specifically stated by use of the word “only”, the phrase “based on X” does not mean “based only on X.”

As used herein, including in the claims, the phrase “using” means “using at least,” and is not exclusive. Thus, e.g., the phrase “using X” means “using at least X.” Unless specifically stated by use of the word “only”, the phrase “using X” does not mean “using only X.”

In general, as used herein, including in the claims, unless the word “only” is specifically used in a phrase, it should not be read into that phrase.

As used herein, including in the claims, the phrase “distinct” means “at least partially distinct.” Unless specifically stated, distinct does not mean fully distinct. Thus, e.g., the phrase, “X is distinct from Y” means that “X is at least partially distinct from Y,” and does not mean that “X is fully distinct from Y.” Thus, as used herein, including in the claims, the phrase “X is distinct from Y” means that X differs from Y in at least some way.

As used herein, including in the claims, a list may include only one item, and, unless otherwise stated, a list of multiple items need not be ordered in any particular manner. A list may include duplicate items. For example, as used herein, the phrase “a list of XYZs” may include one or more “XYZs”.

It should be appreciated that the words “first” and “second” in the description and claims are used to distinguish or identify, and not to show a serial or numerical limitation. Similarly, the use of letter or numerical labels (such as “(a)”, “(b)”, and the like) are used to help distinguish and/or identify, and not to show any serial or numerical limitation or ordering.

No ordering is implied by any of the labeled boxes in any of the flow diagrams unless specifically shown and stated. When disconnected boxes are shown in a diagram the activities associated with those boxes may be performed in any order, including fully or partially in parallel.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A method of performing construction comprising:
(A) providing first information regarding a first construction site;
(B) providing second information regarding first construction work to be performed at the first construction site;
(C) based at least in part on the first information and/or the second information, identifying a first construction vehicle to perform the first construction work;
(D) based at least in part on the first information and/or the second information and the first construction vehicle identified in (C), determining a first route for the first construction vehicle;
(E) transmitting to the first construction vehicle, by a transmitter, third information based at least in part on the first route;
(F) controlling remotely, by a transmitter and a navigation system, the first construction vehicle to perform the first route within the first construction site.

2. The method of claim 1 wherein the first construction site includes a paving construction site.

3. The method of claim 1 wherein the first information includes a construction site map.

4. The method of claim 1 wherein the first construction work includes paving construction work.

5. The method of claim 1 wherein the first construction vehicle is an unmanned vehicle.

6. The method of claim 1 wherein the first construction vehicle includes at least one of a paver vehicle, a double-drum roller, a single-drum roller, and a tire roller.

7. The method of claim 1 wherein the third information includes a first construction vehicle starting location within the first construction site.

8. The method of claim 1 wherein the third information includes at least one of a compaction overlap, number of compaction passes, compaction speed, vibration mode, and sprinkler mode.

9. The method of claim 1 wherein the third information includes information relating to at least one of U-turns, back-and-forth rolling, diagonal translation, and lane changes.

10. The method of claim 1 wherein a least a portion of the first information is captured using a site boundary mapping device.

11. The method of claim 1 further comprising:
(D)(1) based at least in part on the first information and/or the second information and the first construction vehicle identified in (C), determining at a first construction work parameter;
(E)(1) transmitting to the first construction vehicle, by a transmitter, fourth information based at least in part on the first construction work parameter;
(F)(1) controlling remotely, by a transmitter and a navigation system, the first construction vehicle to implement at least one first construction work parameter.

12. The method of claim 11 wherein the fourth information includes at least one of a work length, a rolling start mode, a work width, a margin width, and a length of a rolling section.

13. The method of claim 11 wherein the fourth information includes information relating to at least one of initial rolling, re-rolling, and final rolling.

14. The method of claim 1 further comprising:
(F)(1) prior to (F), remotely commanding, using a transmitter, the first construction vehicle to perform an auto-initialization process.

15. The method of claim 14 wherein the auto-initialization process includes a self-inspection.

16. The method of claim 14 further comprising:
(F)(2) receiving, by a transmitter, auto-initialization information from the first construction vehicle.

17. The method of claim 1 further comprising:
(G) providing fourth information regarding second construction work to be performed at the first construction site;
(G) based at least in part on the first information and/or the fourth information, identifying a second construction vehicle to perform the second construction work;
(H) based at least in part on the first information and/or the fourth information and the second construction vehicle identified in (G), determining a second route for the second construction vehicle;
(I) transmitting to the second construction vehicle, by a transmitter, fifth information based at least in part on the second route;
(J) controlling remotely, by a transmitter and a navigation system, the second construction vehicle to perform the second route within the first construction site.

18. The method of claim 17 wherein the fifth information includes a second construction vehicle starting location within the first construction site.

19. The method of claim 17 wherein the fifth information includes at least one of a compaction overlap, number of compaction passes, compaction speed, vibration mode, and sprinkler mode.

20. The method of claim 17 wherein the fifth information includes information relating to at least one of U-turns, back-and-forth rolling, diagonal translation, and lane changes.
